(19) United States
(12) Patent Application Publication
(10) Pub. No.: US 2015/0365121 A1
(43) Pub. Date: Dec. 17, 2015

(54) MANEUVERABLE HANDLE AND CASE FOR ELECTRONIC DEVICES

(71) Applicant: Gerald SMITH, Columbia, SC (US)

(72) Inventor: Gerald SMITH, Columbia, SC (US)

(21) Appl. No.: 14/302,542

(22) Filed: Jun. 12, 2014

(51) Int. Cl. H04B 1/3888; H04M 1/02

(52) U.S. Cl. CPC H04B 1/3888; H04M 1/0202

(57) ABSTRACT

A protective tablet case including a retractable handle is provided. In a preferred embodiment, the case comprises a front cover that fits over the front of a tablet device and snaps into a separate rear cover fitting over the back of the device, resulting in a protective case layer covering the peripheral edge of a tablet. In a preferred embodiment, the rear cover piece includes a sleeve that is affixed to the rear cover, the sleeve enclosing a paddle shaped handle that may be extended or slide outward from the sleeve when in use, and subsequently the handle may be retracted or slide back into the sleeve when not in use.

### BACKGROUND OF THE INVENTION

The present invention relates generally to a protective case for an electronic device such as a tablet, an e-reader, or smart phone. More specifically, the present invention relates to a protective case for tablet devices, wherein said case includes a slidable handle that extends outwardly for easier and more comfortable use of the electronic device. It is also contemplated that alternative embodiments of this invention could be used on smaller devices such as e-readers, smart phones, and the like.

Smart phones, tablet computers, e-readers, personal electronic assistants, as well as other portable electronic devices are widely used and have become a pervasive part of our lives. Such devices often contain sensitive electronics and are subject to damage if dropped during use. Many devices contain interactive touchscreen type displays made of glass or other fragile materials. In order to design these complicated electronic devices for real world application, it is often necessary to utilize some form of protective case to shield and protect the electronic devices from damage due to drops or falls. Many different types and designs of cases exist and provide a wide range of protections and features. Cases may range from purely decorative to utilitarian, from soft pliable cases, to co-molded soft and hard cases to rigid cases.

The majority of tablets and cell phones include cameras for taking photographs and recording videos. The lenses of these cameras are located on the periphery of the electronic device, making it difficult to both hold the device and press the photo capture button simultaneously. Oftentimes, because of the location of the camera lens, a user holding the device might accidently obstruct the lens with his or her hand or fingers, hindering the ability to take a clear photograph or video. Furthermore, if someone is positioning his or her hands as not to obstruct the lens, it is more likely that the electronic device may accidently be dropped or slip out of a person's grasp.

The size and weight of most tablets can make it awkward, and sometimes very difficult, to hold the tablet with one hand. This is especially true for children and people with arthritis or smaller hands. Additionally, it can become uncomfortable for someone to hold the tablet device for longer periods of time, such as while reading an electronic book or watching a movie.

Therefore, it would be desirable to provide a protective case that includes a handle to facilitate capturing unobstructed photos and videos while allowing a user to hold the device more securely. Moreover, it would be desirable to provide a protective case with a handle that allows for a more ergonomic operation of a tablet device, especially for longer periods of time. It would be especially beneficial for those with arthritis or disabilities, or who otherwise might not be able to hold a tablet device, to provide a protective case with an extendable handle that can be inserted into a docking device on a wheelchair or table.

### BRIEF SUMMARY OF THE INVENTION

In accordance with one aspect of the invention, a protective tablet case including a retractable handle is provided. In a preferred embodiment, the case comprises a front cover that fits over the front of a tablet device and engages or snaps into a separate rear cover fitting over the back of the device, resulting in a protective case layer covering the peripheral edge of a tablet device. The rear cover piece may include a sleeve that is affixed to and centrally located on the outer surface of the rear cover, the sleeve adapted to receive a handle that may be extended or slide outward from the sleeve when in use, and subsequently the handle may be retracted or slide back into the sleeve when not in use.

The handle is preferably attached to the back cover using a swivel means to allow for rotation of the handle from landscape to portrait orientation. The handle may also include a spring-loaded button that can engage in either of two corresponding slots that may be present on the proximal and distal end of the sleeve, thus locking or securing the handle inside the sleeve in a refracted position, or extending outwardly from the case in an operational position, respectively.

The case may be constructed from any suitable material, preferably plasticized rubber, and may be any color or desired design. Any area of the protective cover, preferably including the handle portion, may be texturized for better gripping. In one embodiment, the handle may include a hole for attaching a lanyard, wrist strap, or the like.

### BRIEF DESCRIPTION OF THE DRAWINGS

These and other features, aspects, and advantages of the present invention will become better understood with regard to the following description, appended claims, and accompanying drawings where:

FIG. 1 is a perspective view of one embodiment of the case with retractable handle illustrated enclosing a tablet device;

FIG. 2 is a front view of one embodiment of the case with retractable handle illustrated enclosing a tablet device;

FIG. 3 is a side view of one embodiment of the case with retractable handle;

FIG. 4 is an exploded side view of one embodiment of the case with retractable handle, showing both the front cover and back cover piece with a tablet device disposed therebetween;

FIG. 5 is a rear view of one embodiment of the case with retractable handle, illustrating the handle in an extended, locked position and wherein the swivel is positioned for holding a tablet device in landscape orientation;

FIG. 6 is a rear view of one embodiment of the case with retractable handle, illustrating the handle inserted and locked in the refracted position within sleeve, with the handle and swivel rotated in position for holding a tablet device in portrait orientation;

FIG. 7 is an exploded cross sectional side view of one embodiment of the case with retractable handle, showing both the front cover and back piece with a tablet device disposed therebetween.

### DETAILED DESCRIPTION OF THE INVENTION

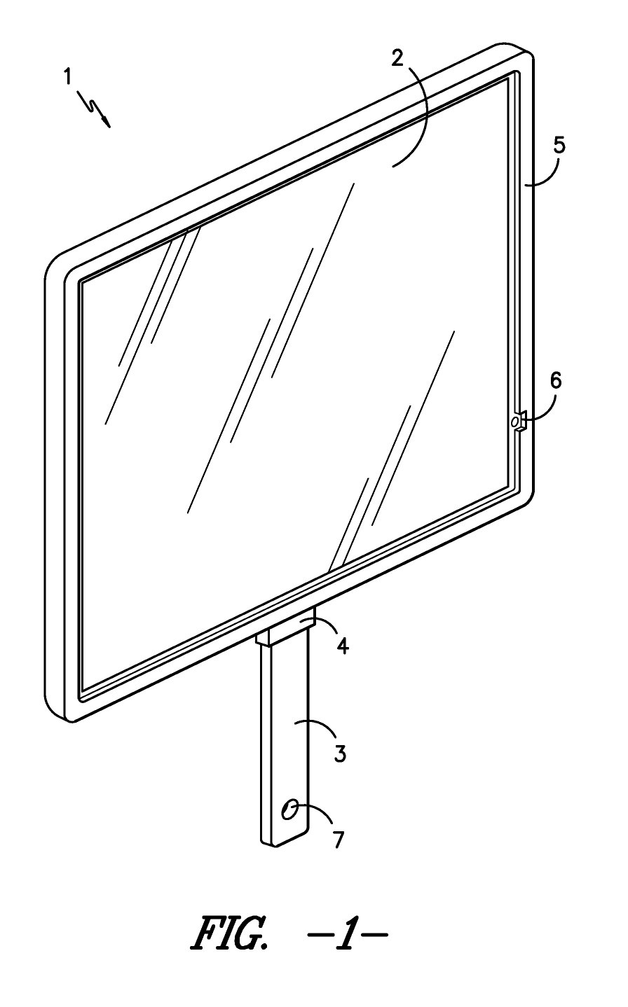

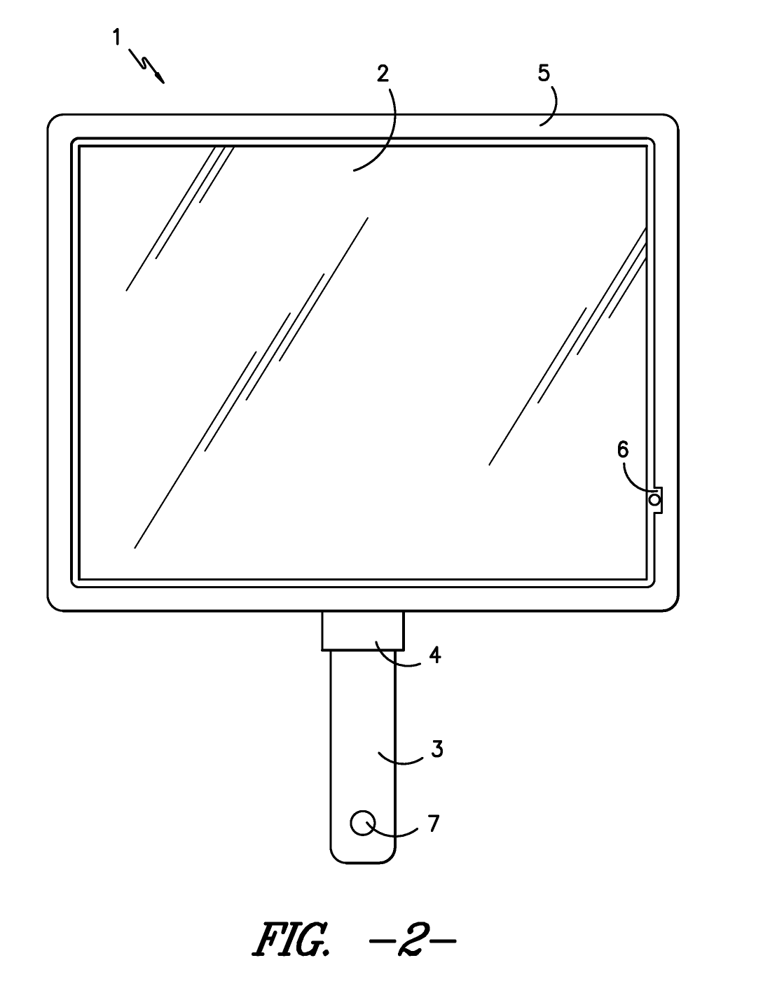

FIGS. 1 and 2 illustrate one embodiment of the case 1 with retractable handle 3 enclosing and protecting a tablet device 2. The retractable handle 3 is shown fully extended from the sleeve 4, showing how one could grasp the handle 3 and easily hold the tablet device 2 in an upright position with the tablet 2 in landscape orientation. The inner edge of the front case frame 5 may include a notch 6 or indentation corresponding to the location of the camera lens and aperture; this notch 6 may be provided to allow for ample protective coverage of the tablet 2, while not obstructing the necessary camera components. In a preferred embodiment, the handle 3 may also include a hole 7 in the distal end wherein a lanyard, wrist strap, or the like may be inserted.

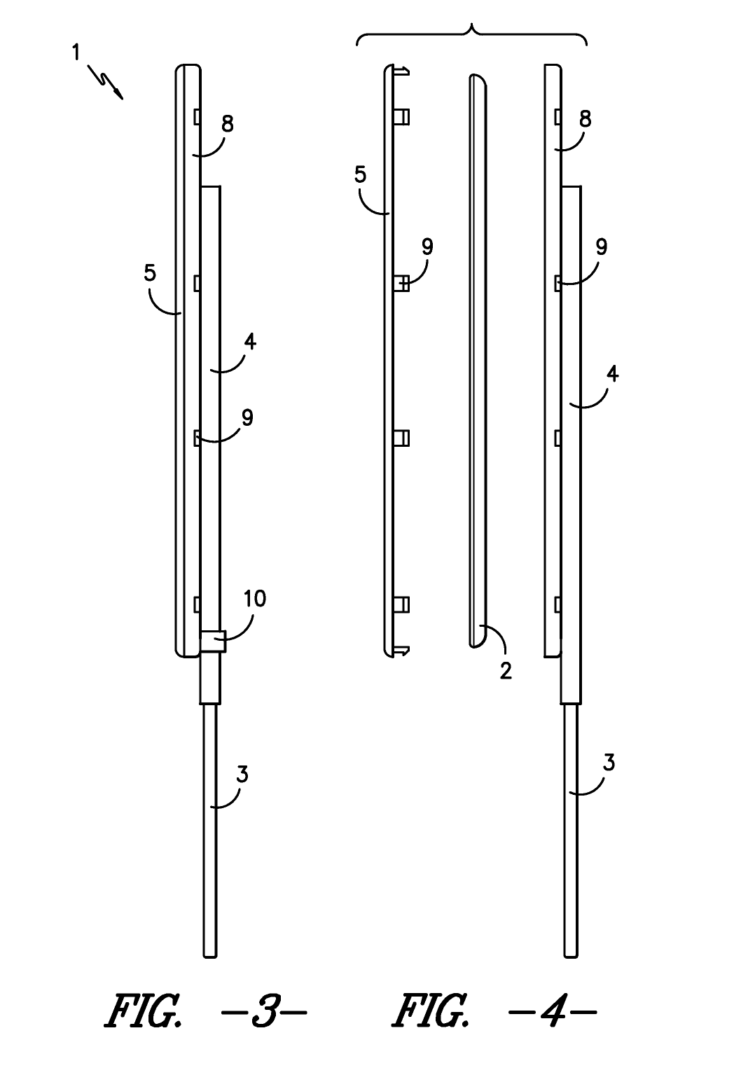

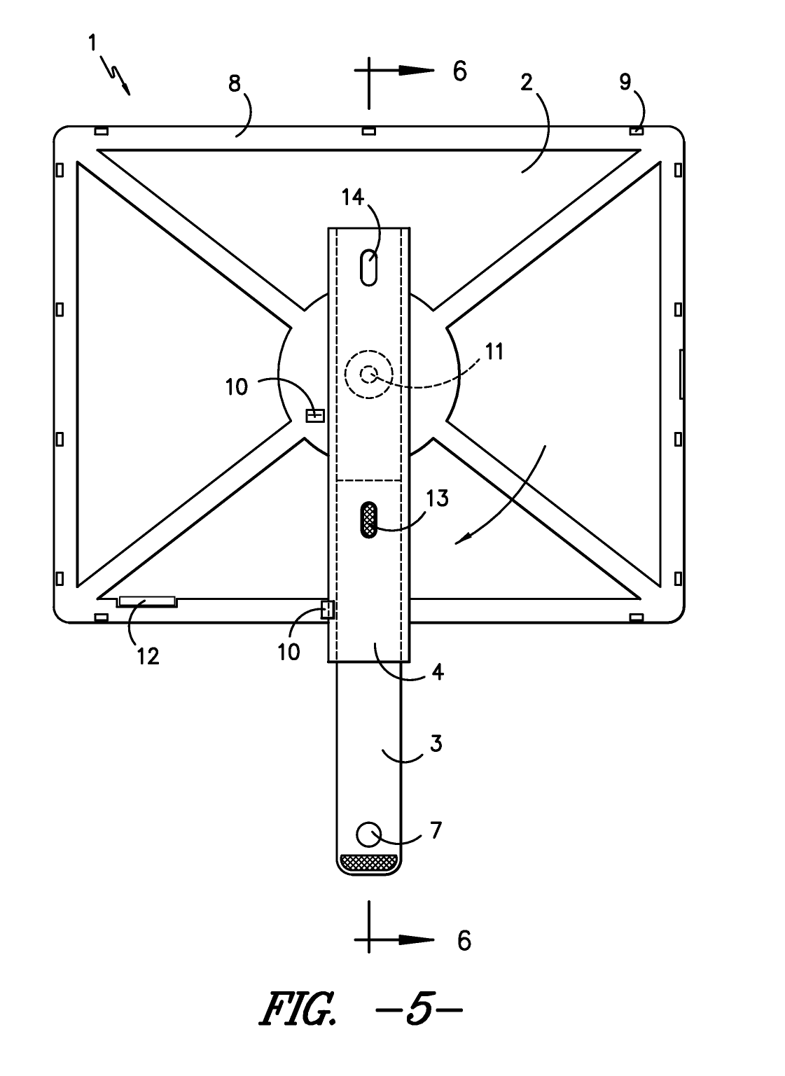

FIG. 3 illustrates a side view of one embodiment of the case 1 with retractable handle 3 as it would appear with the front cover frame 5 and back cover piece 8 snapped together, with the handle 3 fully extended. Preferably, the sleeve 4 fits almost flush with the back cover piece 8 so that the handle 3 does not extend beyond the periphery of the case 1. FIG. 4 shows an exploded side view of an embodiment whereby a front cover frame piece 5 may fit over the front of a tablet device 2 and snap together with a back cover piece 8. The attachment of the front 5 and back cover 8 pieces may be accomplished through any suitable attachment means or interlocking mechanism, including snap-fit components 9, as shown.

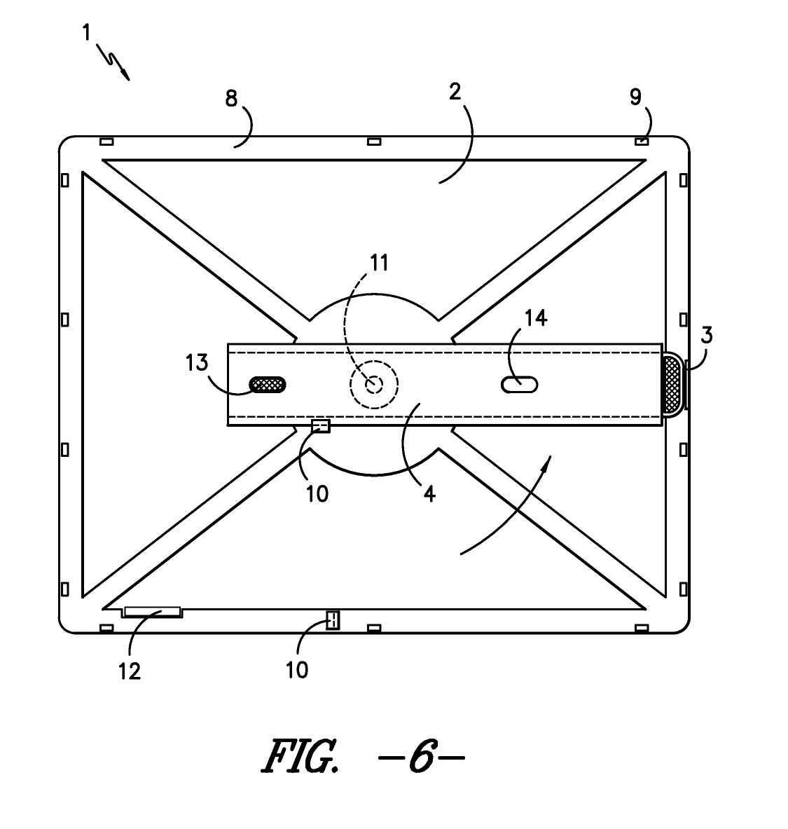

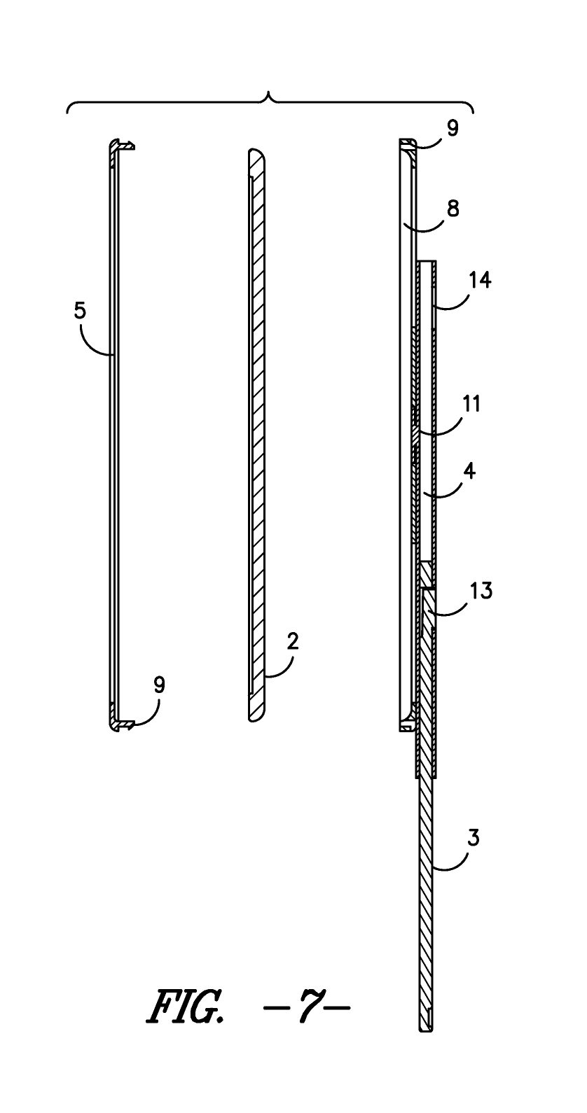

FIGS. 5 and 6 illustrate a rear view of a preferred embodiment of the present invention. FIG. 5 shows the handle 3 fully extended from the sleeve 4 for holding the tablet device 2 in landscape orientation. FIG. 6 shows the handle 3 inserted in the sleeve 4 with the sleeve 4 positioned for use in portrait orientation. A release 12 may be present on the rear 8 of the case to disengage the front frame 5 from the rear cover 8 so that the tablet device 2 may be removed from the case 1. The protective components of the back cover piece 8 may be an X-formation, allowing the back of the tablet 2 to partially show through, as seen in FIGS. 5 and 6. It is contemplated that the protective casing of the back cover piece 8 may be any suitable design, including one solid piece that covers the entire back of the tablet 2.

In one embodiment, a sleeve 4 enclosing the handle 3 may be affixed, preferably using a swivel attachment means 11, to a central location on the back cover piece 8. The sleeve 4 and handle 3 may be either permanently affixed or detachable. Any appropriate type of swivel mechanism may be used. In a preferred embodiment, the swivel attachment 11 may consist of a disc and socket type mechanism, whereby a socket piece may be affixed to the rear cover 8 and engage a corresponding ball or disc type structure that may be affixed to the sleeve 4, thus allowing the sleeve 4 to rotate with respect to the rear cover 8. It is contemplated that the sleeve 4 and handle 3 may be rotated from landscape orientation to portrait orientation using the swivel attachment means 11, thus allowing a user to rotate the handle 3 to the desired position for use. This swivel attachment 11 may also include a locking component whereby a small protrusion may be present on the ball/disc to engage a groove that may be present in the socket piece, thus snapping or locking the swivel mechanism in the desired orientation during rotation. In either orientation, it is preferable that the handle 3 is held in a generally perpendicular position with respect to the lateral edge of the device 2.

A stay 10 may be affixed on an edge of the rear cover 8 in any suitable location for holding or securing the handle 3 in the desired orientation. The stay 10 may be cuff-shaped and engage the sleeve 4 during rotation to hold the sleeve 4 in place and prevent any further rotation. For example, a stay 10 may be present along a longitudinal (or longer) edge of the case 1 to secure the sleeve 4 in landscape orientation; similarly, a stay 10 may be present on a lateral (or shorter) edge to secure the sleeve 4 in portrait orientation. FIG. 6 shows the stay 10 being used to position the sleeve 4 in portrait orientation, with the handle 3 fully enclosed in the sleeve 4. In this fashion, a user would extend the handle 3 from the sleeve 4 and then rotate the handle 3 to the desired orientation until it slides into the stay 10, thus holding the handle 3 in place.

The handle 3 preferably includes means for securing the handle 3 in the refracted or extended position. In a preferred embodiment, the handle 3 may include a spring-loaded button 13 that may engage in a corresponding slot 14 present on the proximal end of the sleeve 4, thus locking or securing the handle 3 inside the sleeve 4. To use the handle 3, one may simply press down the spring-loaded button 13, disengaging it from the slot 14, and slide the handle 3 outwardly from the sleeve 4. A separate slot 14 may be present on the distal portion of the sleeve to re-engage the spring-loaded button of the handle 13, thus locking or securing the handle 3 in an extended, operational position. The handle 3 may be partially or completely texturized for a more secure grip.

FIG. 7 shows an exploded, cross-sectional side view of an embodiment of the case 1 with retractable handle 3 whereby a front frame piece 5 may fit over the front of a tablet device 2 and snap together with a back cover piece 8.

In a preferred embodiment, the case 1 with retractable handle 3 may be constructed from a dense, durable plasticized rubber, although any other suitable materials may be used. The case 1 may be any color or decorative design as desired without taking away from the utility of the invention. Additionally, the case 1 may be constructed and designed to fit any brand of electronic tablet, e-reader, smart phone, or any other portable electronic device as needed and is not limited to merely one brand or one type and size of device. It is further contemplated that a docking device may be used in conjunction with the present invention to allow a device to be used hands-free or allow for multiple people to view a tablet device at one time. Furthermore, a corresponding docking device may be attached to a wheelchair or bedside to provide for use by the disabled or someone otherwise unable to hold the case 1 by hand.

Although the present invention has been described in considerable detail with reference to certain preferred versions thereof, other versions are possible. Therefore, the spirit and scope of the appended claims should not be limited to the description of the preferred versions contained herein. All features disclosed in this specification may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A protective casing for a portable electronic device, the casing comprising:
a front cover frame adapted to fit over the front of a portable electronic device;
said front cover frame removably attached to a back cover panel, forming a protective enclosure for a portable electronic device; and
a rotatable sleeve affixed to the outer surface of said back cover panel, said sleeve including a slot on a proximal and distal end thereof, said sleeve enclosing an extendable handle, said handle including means for securing said handle in a retracted position or an extended position.

2. The protective casing of claim 1 wherein the portable electronic device is one of a tablet, smart phone, and electronic reader.

3. The protective casing of claim 1 whereby the casing is constructed of a durable plasticized rubber.

4. The protective casing of claim 1 further including a stay affixed to an edge of said rear cover panel for securing said handle in a generally perpendicular position with respect to said edge when handle is in use.

5. The protective casing of claim 1 wherein the extendable handle further includes a hole for attaching a lanyard, wrist strap, or the like.

6. The protective casing of claim 1 wherein the means for securing said handle in a retracted position or an extended position is a spring-loaded button.
